(19) United States
(12) Patent Application Publication
(10) Pub. No.: US 2007/0067188 A1
(43) Pub. Date: Mar. 22, 2007

(54) INTEGRATED PASSCODE REFERRAL SYSTEM AND METHOD FOR FACILITATING THE ADMINISTRATION OF PSYCHOLOGICAL ASSESSMENTS

(76) Inventor: Sean C. McDevitt, Scottsdale, AZ (US)

Correspondence Address: WEISS & MOY PC, 4204 NORTH BROWN AVENUE, SCOTTSDALE, AZ, 85251, US

(21) Appl. No.: 11/532,351

(22) Filed: Sep. 15, 2006

Related U.S. Application Data
(60) Provisional application No. 60/718,075, filed on Sep. 16, 2005.

(51) Int. Cl. G06Q 10/00

(52) U.S. Cl. 705/2

(57) ABSTRACT

An integrated passcode referral system and method for facilitating the administration of psychological assessments. The system allows a professional to refer tests to patients without the professional having to purchase any of them; track the referrals; view patient test scores and testing information; and view a list of available tests. The system also allows patients to conveniently access, fill out, and submit the test(s) referred by the professional; and to receive confirmation that the completed test was received by the professional. And the system allows an administrator to track registration and approval of professionals as system users; maintain the inventory of available tests; and maintain the billing and financial information needed to administer purchase orders of tests from contracting agencies.

### CROSS-REFERENCE TO RELATED APPLICATIONS

This application claims priority to a corresponding provisional application U.S. Ser. No. 60/718,075, filed Sep. 16, 2005 in the name of the applicant of this application.

### FIELD OF THE INVENTION

This invention relates generally to professional psychological assessments, and more specifically, to an integrated passcode referral system and method for facilitating the administration of psychological assessments.

### BACKGROUND OF THE INVENTION

Psychologists and other behavioral health professionals use psychological assessments to evaluate and diagnose their patients. In order to assist the evaluation of the patient, the professional may ask a patient to complete his/her own psychological assessment measure (hereinafter “test”), or the professional may ask a parent, a teacher, a caregiver, etc. to complete the test for the patient based on their observations. It should be clearly understood that these tests include questionnaires, checklists, inventories, surveys, and any other device used by behavioral health and other professionals to assist them in the evaluation process.

The traditional way for psychologists and other behavioral health professionals to conduct initial psychological assessments has been for the professional to first meet in person with the individual patient (or patient's guardian/caregiver). During that first meeting, the professional presents the patient with a test, usually in the form of a questionnaire. For tests that must be administered in the presence of a professional, such as an MMPI-2, the patient must remain in the professional's office until he/she has completed the test. However, most tests may be administered outside of the professional's presence and therefore may be completed by the patient outside of the professional's office. Once the test is submitted to the professional, he/she then scores the test and interprets the score. After the professional has finished scoring the test and interpreting the score, the patient is asked to meet with the professional again in order to discuss the results and any needed treatment.

Sometimes, professionals perform additional psychological assessments after the patient's treatment has already begun. Such is necessary when the patient does not appear to be responding to the current treatment. Once again, the patient must visit the professional's office to receive the new test.

Customarily, the tests appear in paper form and need to be filled out by hand by the patient. The professional then either scores those paper form tests by hand or uses a computer to score it. In order to use the computer, however, the professional must first manually enter the test answers into the computer. Either method of scoring these paper form tests may prove to be time consuming for the professional. Some tests may be filled out by the patient on a computer at the professional's office, although this computer format is very rare.

One problem with the existing method is that the patient must physically come in to the professional's office just to receive the test. This method is not cost efficient to the patient who must travel to the professional's office and pay for the office visit simply to receive a test. Another problem with this traditional method stems from the fact that the professional must purchase these tests from testing companies. If the patient does not complete or submit the test, then the money that the professional paid for it is lost.

Some testing companies, such as Harcourt Assessment, sell online test uses to professionals. However, the purpose of that is merely the sale of tests rather than providing professional supervision of online assessment. Furthermore, those companies require the purchase of the tests prior to their use by the professional.

Therefore a need existed to provide an integrated passcode referral system and method for administering psychological assessments. The system would be an easy-to-use, accurate, and secure system that facilitates the administration of psychological assessments by allowing a credentialed professional to issue a unique passcode to a patient to grant the patient access to confidential information, scoring tests, generating reports from the test scores, and immediately delivering the reports to the professional. This represents a professionally supervised method of psychological assessment online. Rather than providing results on the computer screen where the patient may see them, the reports are delivered directly to the professional, thereby giving the professional time to integrate the test results before having to tell the patient about their significance. The system would provide information sufficient and accurate enough to allow the professional to maximize the time spent with patients during their meetings. The system would allow a professional to refer tests to patients without the professional having to purchase any of them; track the referrals; view patient test scores and testing information; and view a list of available tests. The system would also allow patients to conveniently access, fill out, and submit the test(s) referred by the professional; and to receive confirmation that the completed test was received by the professional. And the system would allow an administrator to track registration and approval of professionals as system users; maintain the inventory of available tests; and maintain the billing and financial information needed to administer purchase orders of tests from contracting agencies such as, but not limited to, hospitals, social services agencies, clinics, etc.

### SUMMARY OF THE INVENTION

It is an object of the present invention to provide a fully integrated passcode referral system and method for facilitating the administration of psychological assessments.

It is another object of the present invention to provide an easy-to-use, accurate, and secure system that facilitates the administration of psychological assessments by allowing a credentialed professional to issue a unique passcode to a patient to grant the patient access to confidential information, scoring tests, generating reports from the test scores, and immediately delivering the reports to the professional.

It is another object of the present invention to provide a system that would provide information sufficient and accurate enough to allow the professional to maximize time spent with patients during their meetings.

It is another object of the present invention to provide a system that will allow a professional to refer tests to patients without the professional having to purchase any of them; track the referrals; view patient test scores and testing information; and view a list of available tests.

It is still another object of the present invention to provide a system that will allow a patient to conveniently access, fill out, and submit the test(s) referred by the professional; and to receive confirmation that the completed test was received by the professional.

It is yet another object of the present invention to provide a system that will allow an administrator to track registration and approval of professionals as system users; maintain the inventory of available tests; and maintain the billing and financial information needed to administer purchase orders of tests from agencies that purchase quantities of tests.

It is yet another object of the present invention to provide a professionally supervised method of psychological assessment online.

### BRIEF DESCRIPTION OF THE PREFERRED EMBODIMENTS

In accordance with an embodiment of the present invention, a method in a computer system for facilitating the administration of psychological assessments is disclosed. The method comprises the steps of referring at least one of a plurality of psychological assessment tests by a professional to a patient, taking the at least one psychological assessment test by the patient, scoring test responses submitted by the patient, and generating a report based on a test score of the patient.

In accordance with an embodiment of the present invention, a method in a computer system for facilitating the administration of psychological assessments is disclosed. The method comprises the steps of entering and storing a plurality of psychological assessment tests in a database, generating a registration number that allows access to the computer system, issuing the registration number to a professional, logging on to the computer system by the professional with the registration number, generating a passcode that allows access to the computer system, entering and storing personal information of a patient into the database, selecting at least one of the plurality of psychological assessment tests for the patient by the professional based upon the personal information of the patient, determining a method of delivering the at least one psychological assessment test to the patient, referring the at least one psychological assessment test to the patient, issuing the passcode to the patient, logging on to the computer system by the patient with the passcode, entering and storing responses of the patient to questions contained in the at least one psychological assessment test, scoring test responses submitted by the patient, generating a report based on a test score of the patient, and storing the report in the database.

In accordance with an embodiment of the present invention, a computer readable medium containing instructions for controlling a computer system for facilitating administration of psychological assessments is disclosed. The computer readable medium contains instructions for referring at least one of a plurality of psychological assessment tests to a patient, taking the at least one psychological assessment test by the patient, scoring test responses submitted by the patient, and generating a report based on a test score of the patient.

The foregoing and other objects, features, and advantages of the invention will be apparent from the following, more particular, description of the preferred embodiments of the invention, as illustrated in the accompanying drawings.

### BRIEF DESCRIPTION OF THE DRAWINGS

The present invention, as well as a preferred mode of use, and advantages thereof, will best be understood by reference to the following detailed description of illustrated embodiments when read in conjunction with the accompanying drawings.

FIG. 1 is a schematic of the passcode referral model.

FIG. 2 is a schematic of a professional's referral interface.

FIG. 3 is a simplified functional block diagram of the system of the present invention.

FIG. 4 is a diagram of the list of available tests.

FIG. 5 is a schematic of a patient's interface.

FIG. 6 is a schematic of an administrator's interface.

FIG. 7 is a portion of a sample test.

FIG. 8 is a portion of a sample professional's version of a report generated for the test of FIG. 7.

FIG. 9 is a portion of a sample patient/caregiver's version of a report generated for the test of FIG. 7.

FIG. 10 is a schematic of an administrator's registration interface.

FIG. 11 is a schematic of an administrator's administration interface.

FIG. 12 is a schematic of an administrator's professionals interface.

FIG. 13 is a schematic of an administrator's contracts interface.

FIG. 14 is a schematic of an administrator's tests interface.

FIG. 15 is a schematic of the system access available to the administrator, professionals and patients.

### DETAILED DESCRIPTION OF THE PREFERRED EMBODIMENTS

The novel features believed characteristic of the invention are set forth in the appended claims. The invention will best be understood by reference to the following detailed description of illustrated embodiments when read in conjunction with the accompanying drawings.

The present invention provides an integrated passcode referral system and method for facilitating the administration of psychological assessments. The system, which is easy-to-use, accurate, and secure, facilitates the administration of psychological assessments by allowing a credentialed professional to issue a unique passcode to a patient to grant the patient access to confidential information, scoring tests, generating reports from the test scores, and immediately delivering the reports to the professional. The passcode referral system and method realigns the relationship between the professional, the patient, and the tests so that the professional may maximize the time spent with the patient during their meetings.

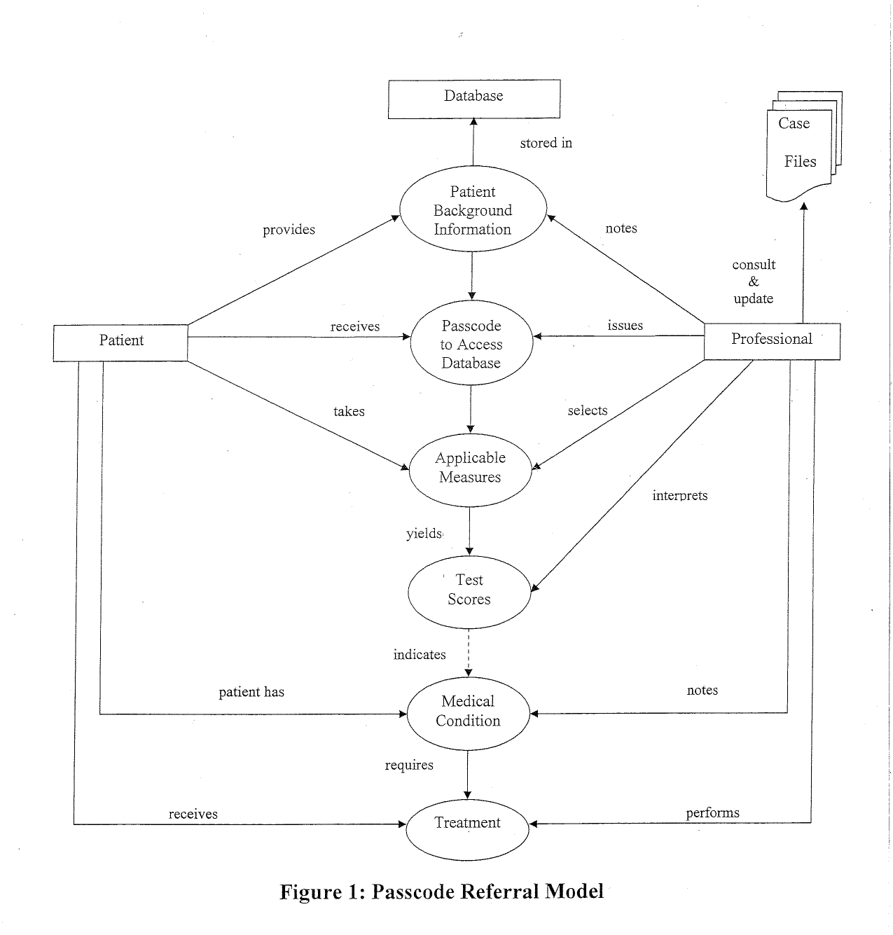

Referring to FIGS. 1-15, details of the system will be disclosed. The system preferably has three different interfaces; an administrator interface, a professional interface, and a patient interface. Each of these three interfaces is preferably accessible from remote locations by a system user. Although these three interfaces are preferred, it should be clearly understood that further substantial benefit may be derived from alternative numbers and types of interfaces. It should also be clearly understood that substantial benefit may be derived from any number of administrators, professionals, and/or patients being system users.

Referring to FIGS. 3 and 15, the computer system may be accessed by an administrator, a professional, and a patient. While the professional and the patient are preferably granted access, an administrator preferably has direct access to the system. By accessing the system, the administrator, the professional, and the patient may each access the database that contains information, including confidential information, on professional system users and their patients.

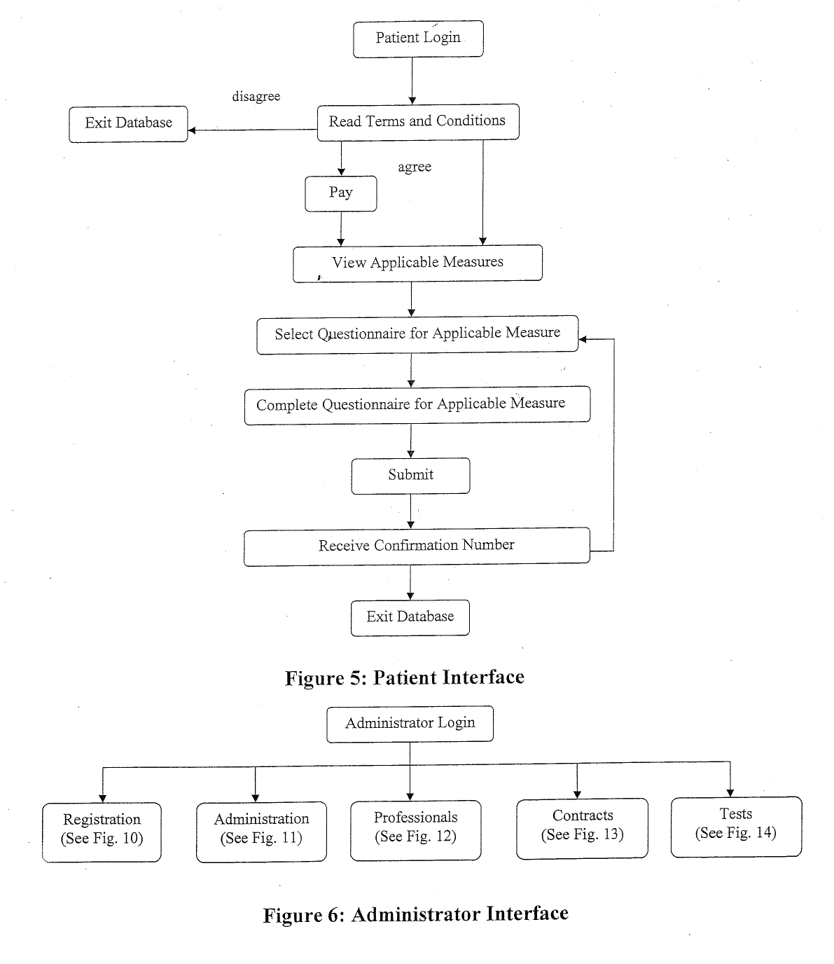

Referring to FIG. 6, the administrator interface is shown. While in the administrator interface, the administrator may edit/change his profile or password, generate/deliver registration numbers to professionals, track the registration and/or approval of professionals as system users, and maintain an inventory of the tests available through the system. The administrator may also view the number of tests that have been issued as well as the associated patient and professional information for each test. In addition, the administrator interface may also be used to maintain the billing and financial information needed to administer purchase orders of the tests from contracting agencies.

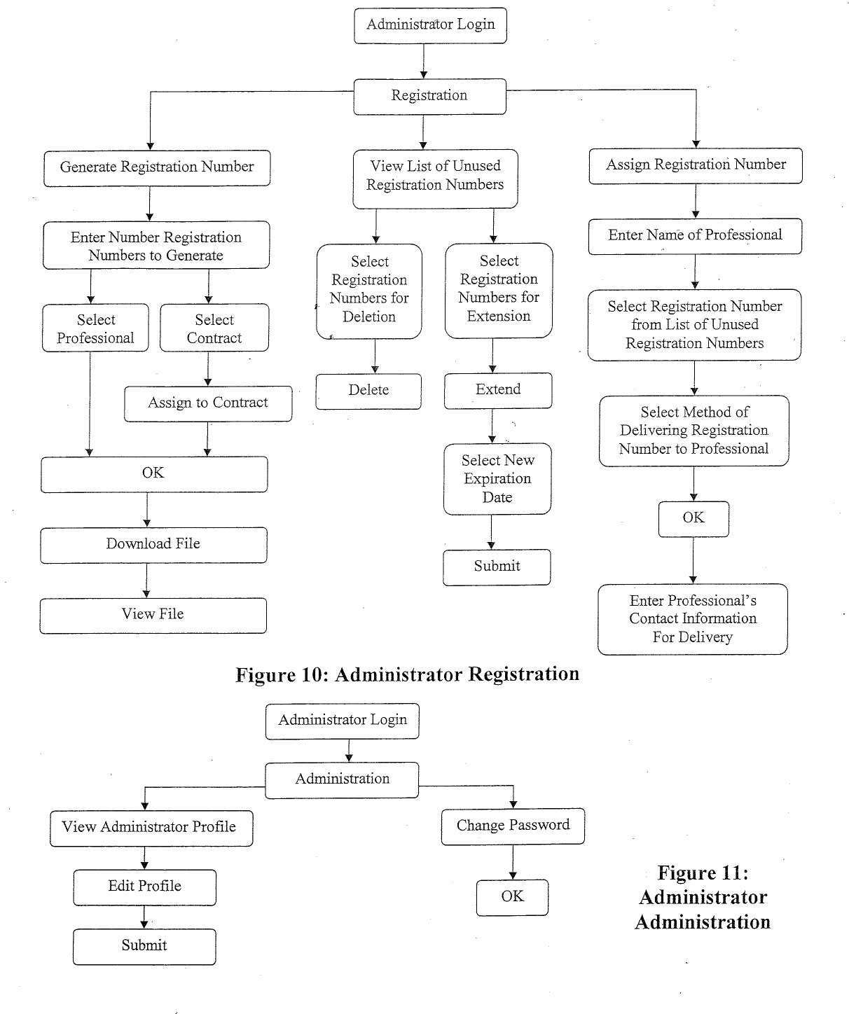

In order for a professional to become a system user, the professional must receive a registration number from the administrator. Referring to FIG. 10, the administrator first logs on to the system. The system preferably allows the administrator to either generate a new registration number or to select one from a list of unused pre-existing registration numbers. While it is preferred that the system allow the administrator to either generate a new registration number or select one from a list of unused pre-existing registration numbers, it should be clearly understood that substantial benefit may nevertheless be derived if the administrator was only allowed to create new registration numbers every time.

Pre-existing registration numbers are those that were created by the administrator for marketing purposes. For example, the administrator may wish to advertise the system to independent professionals or to a group of contracted professionals (agency). The marketing materials sent to the independent professional or to the group of contracted professionals will preferably already contain a registration number for the independent professional to use or contain several registration numbers for the group of contracted professionals to use collectively should they desire to become system users. Preferably, the registration number(s) will be contained in an electronic file that may be downloaded by the independent professional or by the agency. If the targeted professionals (whether independent or contracted with an agency) choose not to become system users, the administrator may allow the unused registration numbers to remain in the system database for later assignment (i.e. extension) or may delete them. If the administrator chooses to extend the registration number, the administrator may also choose an expiration date for the registration number.

After the administrator has entered the name of the professional and has either generated a new registration number or selected one from the list of unused registration numbers, the administrator assigns and delivers the registration number to the professional. The registration number may be delivered to the professional by electronic mail, by facsimile, or any other suitable method of delivery. If the administrator chooses to deliver the registration number by electronic mail, the system automatically generates an electronic mail message containing the registration number and delivers it to the professional's electronic mail address. If the administrator chooses to deliver the registration number by facsimile, the system automatically generates a message containing the registration number and delivers it to the professional's facsimile number. Although electronic mail and facsimile messages are preferred, it should be clearly understood that further substantial benefit may be derived from the use of alternative delivery methods such as, but not limited to, text messaging.

Upon receiving the registration number, the professional logs into the system with the registration number and enters information such as, but not limited to, the professional's name, practice/agency name, contact information, licensing/certification information, licensing/certification type, licensing body, user I.D., and password. This information is preferably stored in the system database. After the professional submits the information, the system automatically generates and delivers a notice to the professional stating that his/her registration is going to be reviewed and that the professional will receive information regarding his/her approval status from the administrator. The notice is delivered according to the contact information provided by the professional (e.g. electronic mail address, facsimile number, etc.). While it is preferred that such a notice be delivered to the professional, it should be clearly understood that substantial benefit may nevertheless be derived without delivery of such a notice.

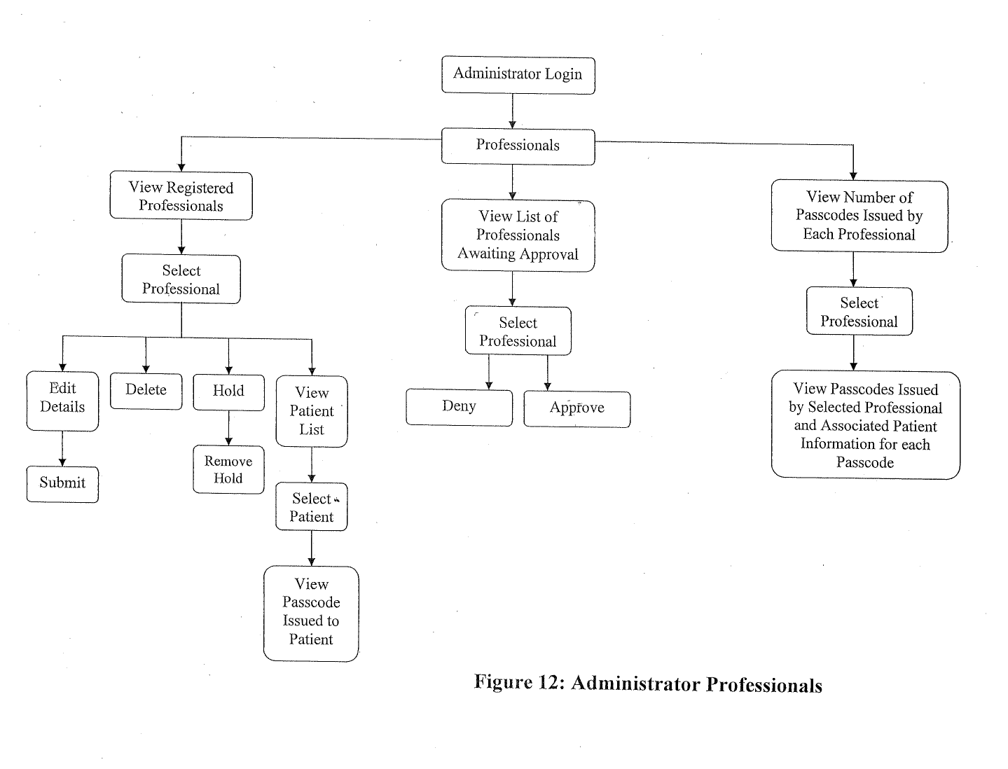

Referring to FIG. 12, when the administrator logs into the system, the administrator may not only view a list of all of the professionals that have been registered as system users, but may also view a list of the professionals that are still awaiting approval as system users. Furthermore, the administrator may also view the information that was submitted by each of the professionals waiting for approval in order to evaluate the professional's credentials. At that time, the administrator may either grant or deny approval to any of the waiting professionals. Preferably, after the administrator approves or denies the professional, the system automatically generates and delivers a message to the professional notifying the professional of his/her approval or denial. Again, this message is sent according to the contact information provided by the professional. While it is preferred that such a message be delivered to the professional, it should be clearly understood that substantial benefit may nevertheless be derived without delivery of such a message. The administrator interface may also view be used to view the passcodes issued by each professional and the associated patient information for each passcode.

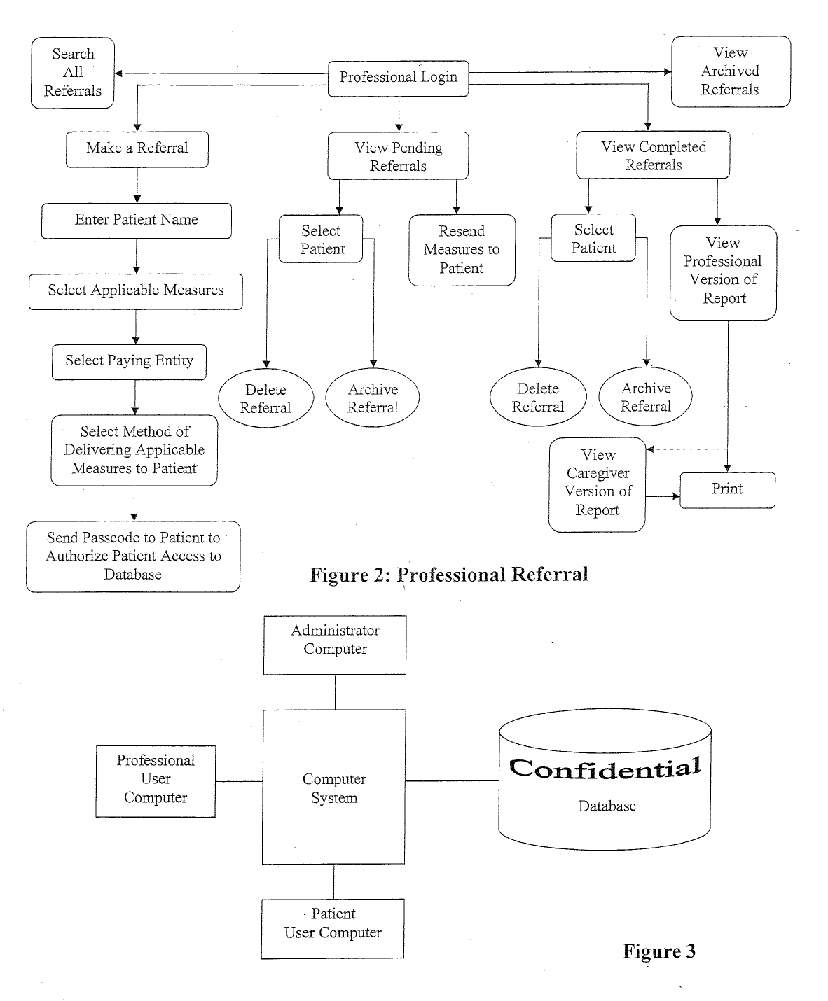

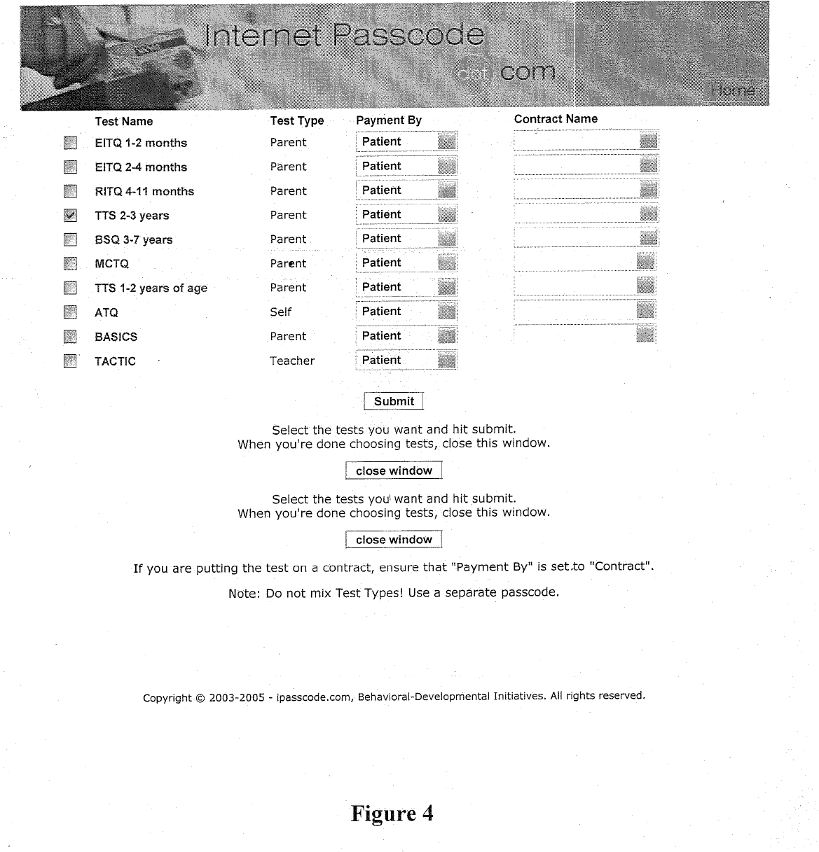

Once approved, the professional may now access the professional interface with the user I.D. and password that he/she had previously created during the registration and approval process. Referring to FIG. 2, the professional interface allows the professional to refer certain tests to patients prior to having to meet in person with the patient. When the professional logs into the system and chooses to make a referral, the system automatically generates a passcode. The professional then enters the name of the patient to whom he/she wishes to issue the passcode. At this time, the professional may view a list of tests that are available through the system (shown in FIG. 4). As a short-cut alternative, the professional may enter a specific passcode referral number(s) associated with the desired test(s).

After the professional selects the test(s) that he/she wishes to refer to the patient, the professional then selects the paying entity, i.e. he/she indicates whether the test should be paid for by the patient, by the professional, or whether it should be billed against a contracting agency contract (shown in FIG. 4). If a group of contracted professionals, or agency, chooses to become a system user, then the agency will preferably enter into a contract with the administrator for the purchase of a certain amount of tests. The agency will then inform the administrator about which of its professionals are permitted to bill against the contract. The professional then delivers the passcode to the patient. The passcode may be delivered to the professional by electronic mail, by facsimile, by mail, by phone, or any other suitable method of delivery. If the professional chooses to deliver the passcode by electronic mail, the system automatically generates an electronic mail message containing the passcode and delivers it to the patient's electronic mail address. If the professional chooses to deliver the passcode by facsimile, the system automatically generates a message containing the passcode and delivers it to the patient's facsimile number. The name of the patient, the passcode, and the patient's contact information, the referred test(s), and the date of delivery are preferably stored in the system database.

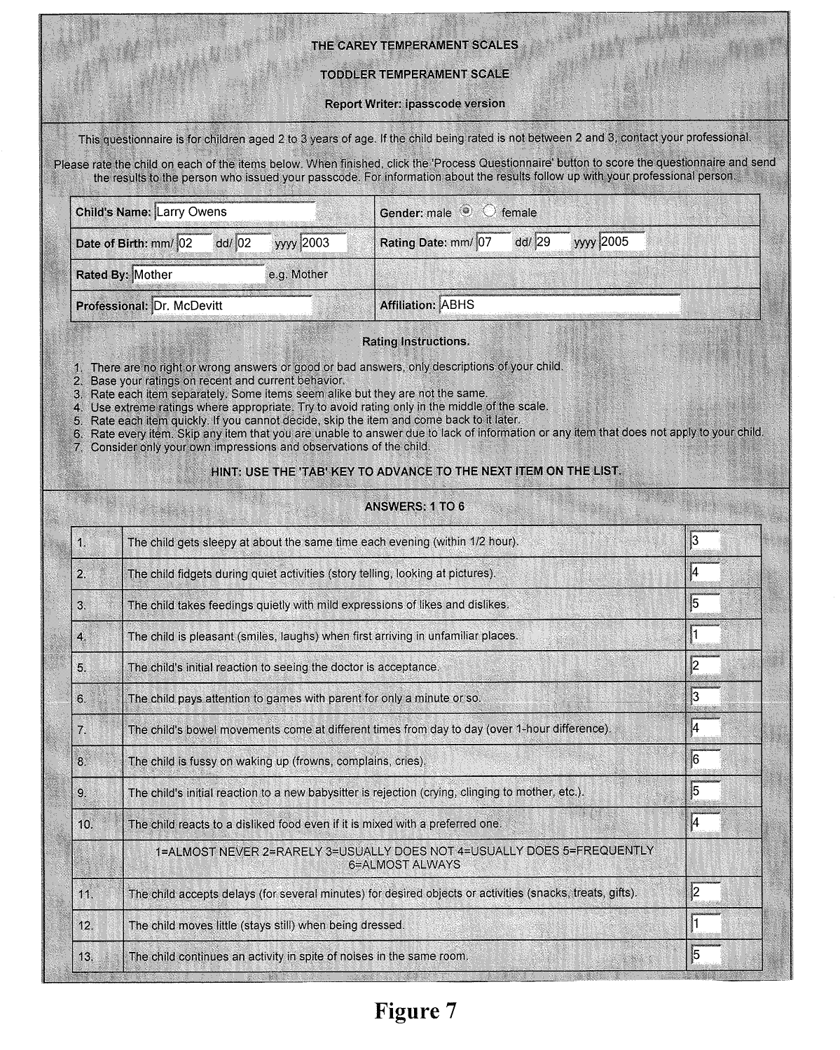

Referring now to FIG. 5, after receiving the passcode, the patient may log into the system and use the patient interface at any time with the passcode. It is preferred, but not necessary, that the patient be presented with “Terms and Conditions of Use” provisos and that the patient agrees to those provisos in order to continue in the patient interface. If the professional chose for the patient to pay for the test(s) (shown in FIG. 2), then the patient will also be required to submit payment information, such as a credit card number, before continuing. Finally, the patient will view the test(s) referred by the professional. When the patient selects a test, the system presents a fillable form questionnaire for the patient to complete (shown in FIG. 7). After the patient completes the test and submits it, the system preferably automatically generates a confirmation number for the patient to keep for his/her records and the patient may exit the system. Preferably, the system will also automatically generate and deliver a notice to the patient that advises him/her to follow up with the professional at a later date. Although such a follow up notice is preferred it should be clearly understood that substantial benefit may nevertheless be derived without it.

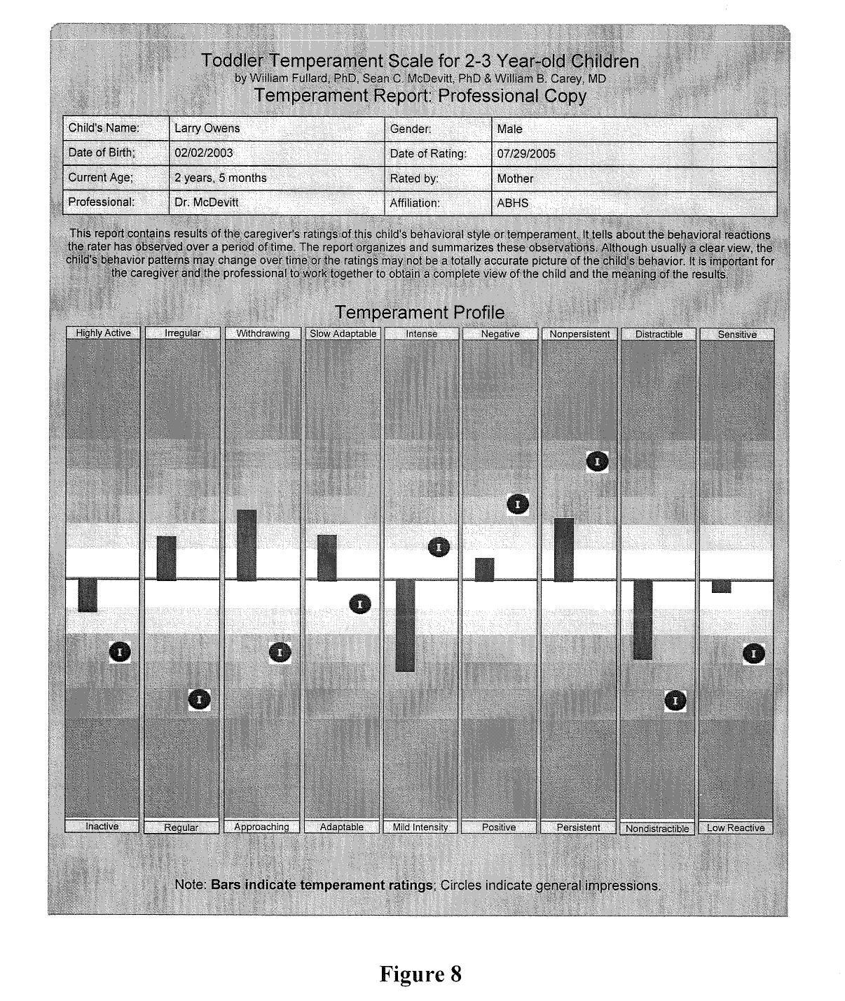

After the patient submits his/her completed test, the system automatically scores the test, interprets the test score, and generates a report (shown in FIG. 8). This report is stored in the system database. It is preferred, though not required, that the system automatically generates and delivers a message to the professional indicating that the report for that patient is available for review. Again, although such a message is preferred it should be clearly understood that substantial benefit may nevertheless be derived without it.

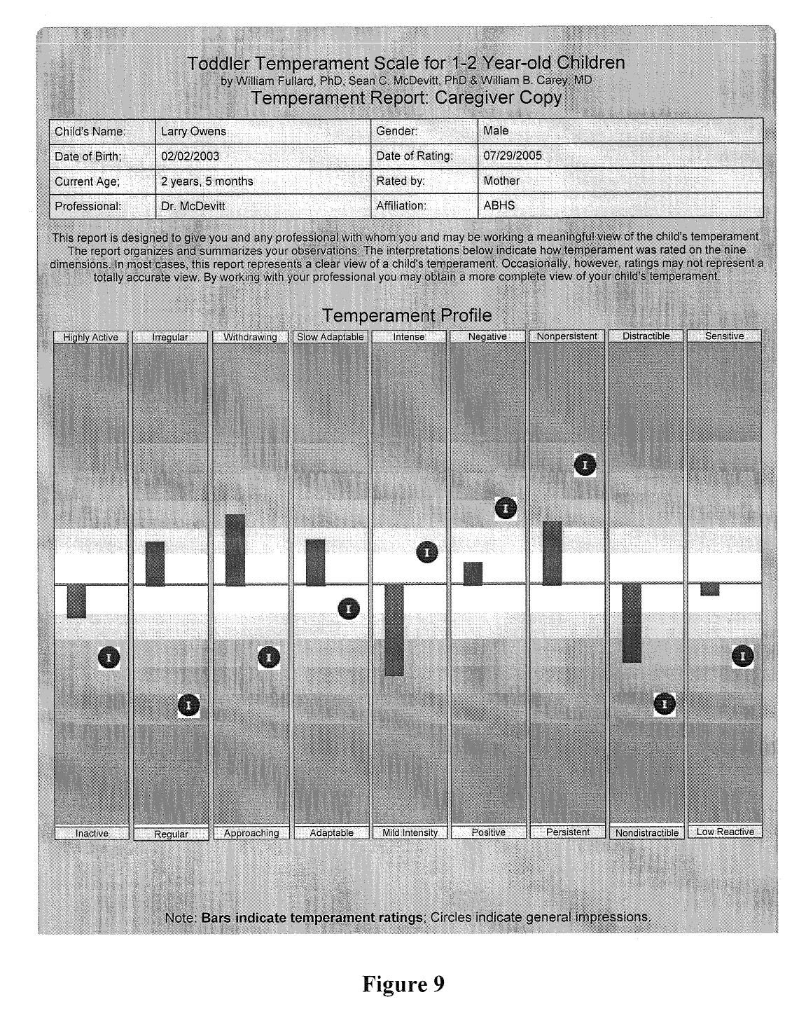

Referring to FIG. 2, when the professional logs into the system again, the professional accesses the database and is allowed to view a list of all patients that have completed their referrals as well as a list of all patients whose referrals are still pending. With respect to the pending referrals, the professional may choose to resend the selected test(s) to the patient if a problem arose during its initial delivery. And with respect to the completed referrals, the professional may select any report he/she wishes to view. At any time, the professional may also delete or archive any of the pending and completed referrals from the system database. It is sometimes preferred that the system generates two versions of the report: a professional version (shown in FIG. 8) and a patient/caregiver version (shown in FIG. 9). Either version of the report may be printed and if the patient/caregiver desired to receive a copy, then the patient/caregiver version could be delivered. For ease of use, the professional interface would preferably have a “search” option to facilitate the location of specific referrals.

By allowing the patient to complete the tests before their meetings, not only is the patient saved a trip to the professional's office, but the professional is provided with information sufficient and accurate enough to allow the professional to maximize the time spent with a patient during their meetings. This is most helpful when used before the professional's first meeting with the patient. Before the first meeting with the patient, the professional will have had an opportunity to view the patient's report and will have been able to determine whether or not the patient has a medical condition. If the patient does have a medical condition, then the professional will also have an indication of what type of treatment to discuss with the patient during their first meeting.

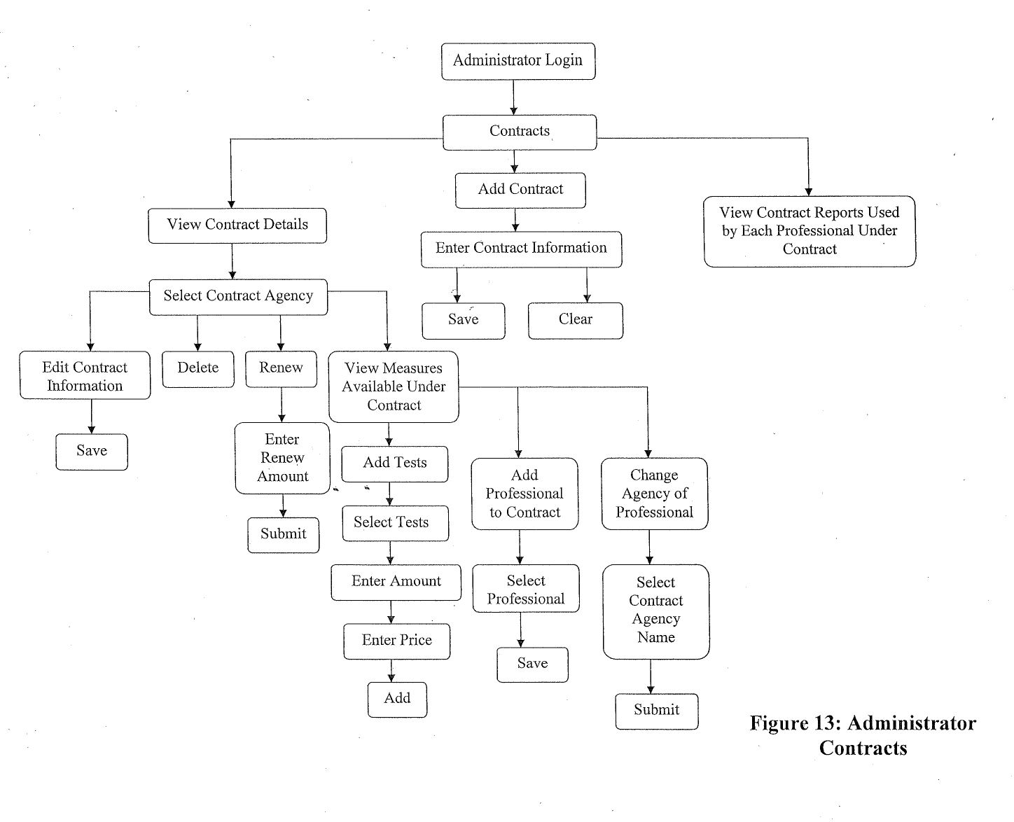

While the professionals and the patients are granted access to the system via registration numbers and passcodes, respectively, the administrator has direct access to the system. Not only does the administrative interface allow the administrator to track the registration and approval of professionals as system users, but it also may be used to view the passcodes issued by each professional and the associated patient information for each passcode (shown in FIG. 12). Furthermore, the administrator may also view the quantity and content of all reports that have been generated by the system (shown in FIG. 13). Still further, the administrator may also be able to conveniently generate and deliver testing updates and other messages, preferably via electronic mail or facsimile, to all of the system users at once. For security purposes, the administrator may also change his/her password (shown in FIG. 11).

Referring to FIG. 13, the administrator interface may also be used to maintain inventory of available tests and to maintain the billing and financial information needed to administer purchase orders of tests from contracting agencies. For example, if an agency contracts to purchase a certain number of tests from the administrator, the administrator may add the test to the system database, thereby making it available for the agency's professionals to refer it to their patients. The administrator may also delete any test from the system database as well as edit/update its description contained in the system. The administrator will also be able to enter and view the contract details in the system, i.e. the name of the contracting agency, the tests that are available through the contracting agency, the purchase price of the tests, and the amount ordered. Furthermore, the administrator will also be able to select/change which professionals will be allowed to bill against the contract (as opposed to the professional or the client paying for the test) when referring the tests to patients. Still further, the administrator will be able to track all of the contracted tests referred by any professional approved by a contracting agency to bill against the contract.

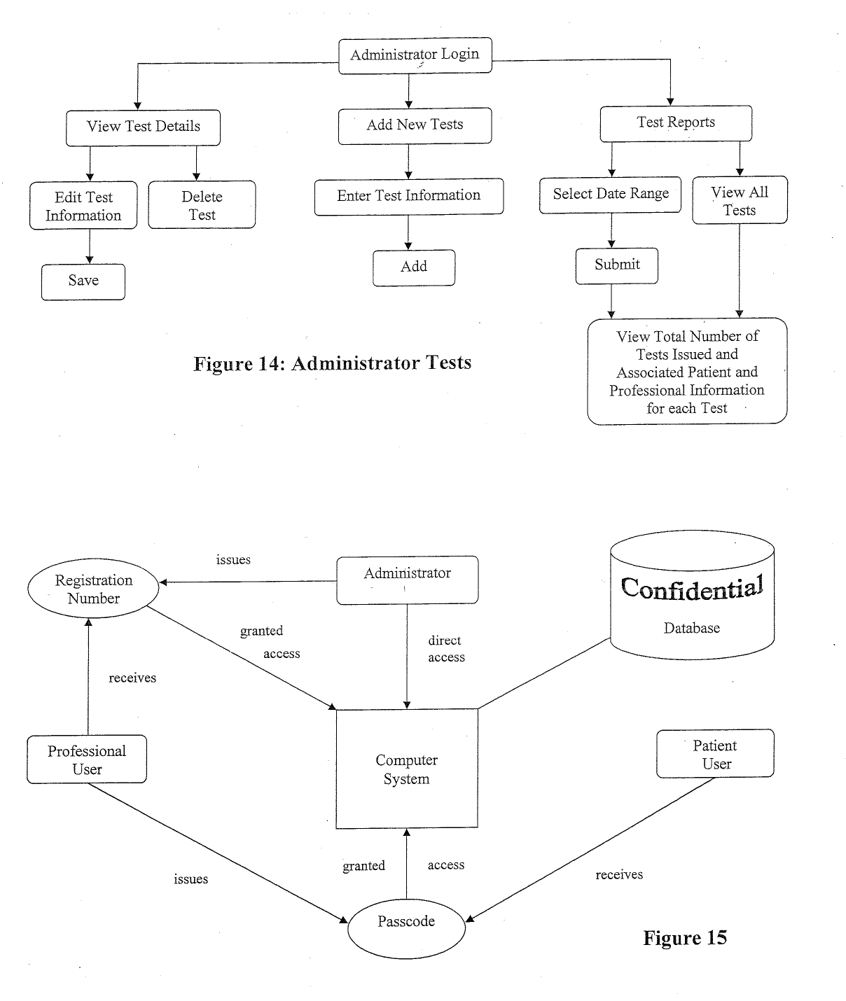

Referring to FIG. 14, the administrator may also view, add, and/or delete the number and types of tests (contracted or not) available in the system database. Preferably, these tests that the administrator stores in the database are provided by certain psychological assessment testing companies and/or test authors. Information about each type of test is also available for view or change by the administrator. Furthermore, the administrator may also view all of the tests that have been referred through the system as well as the associated patient and professional information for each test.

While the invention has been particularly shown and described with reference to preferred embodiments thereof, it will be understood by those skilled in the art that the foregoing and other changes in form and details may be made therein without departing from the spirit and scope of the invention. For example, the present invention may be used to assess human physical conditions or the present invention may be used to test the health or behavior of animals other than humans. Specifically, a medical doctor or veterinarian could issue a passcode to a patient/caregiver so that the patient/caregiver may complete the initial general health questionnaires and the medical doctor or veterinarian may make an initial diagnosis prior to having the patient/caregiver come into the office.

The present invention may also be used in other applications such as in real estate, where a realtor issues a passcode to a buyer to allow the buyer access to information about a confidential listing in the system database so that the buyer may determine whether he/she wishes to see the property. As another example, the present invention may be used in a situation where a database holds the confidential medical records of numerous patients and the physicians may issue passcodes to their patients so that the patients may access their own medical records, and no one else's, for viewing and/or printing. Furthermore, the present invention could be used by a pharmaceutical company conducting a study on a new medication, wherein the study researcher issues passcodes to participants who then access the database and complete an inventory of drug side effects, the results of which the researcher may review conveniently by accessing the database. In addition, a physician may use the present invention to enter a prescription into the database and provide a passcode to the patient. The patient would then provide the passcode to a pharmacist who would use it to access the database and fill the prescription, thereby preventing errors made when reading the physician's handwriting and also preventing forgery of paper prescriptions.

I claim:

1. A method in a computer system for facilitating the administration of psychological assessments, said method comprising:
referring at least one of a plurality of psychological assessment tests by a professional to a patient;
taking said at least one psychological assessment test by said patient;
scoring test responses submitted by said patient; and
generating a report based on a test score of said patient.

2. The method of claim 1 wherein the step of referring at least one of a plurality of psychological assessment tests further comprising the steps of:
entering and storing said plurality of psychological assessment tests in a database;
accessing said computer system by said professional; and
selecting said at least one test to be taken by said patient.

3. The method of claim 2 wherein said plurality of psychological assessment tests in said database being provided by at least one of a testing company and a test author.

4. The method of claim 2 further comprising the step of maintaining an inventory of said plurality of tests stored in said database.

5. The method of claim 2 wherein accessing said computer system by said professional further comprises:
generating a registration number that allows access to said computer system;
issuing said registration number to said professional;
logging on to said computer system by said professional with said registration number; and
registering said professional as a system user.

6. The method of claim 2 wherein said professional accessing said computer system from a remote location.

7. The method of claim 5 wherein registering said professional as a system user further comprising:
entering and storing background information of said professional in said database;
evaluating said background information of said professional by an administrator;
notifying said professional of approval of said professional as a system user.

8. The method of claim 2 wherein selecting said at least one test further comprising:
providing personal information of a patient to said professional;
determining which of said plurality of tests being appropriate based upon said personal information of said patient.

9. The method of claim 1 wherein taking said at least one psychological assessment test by said patient comprises:
accessing said computer system by said patient; and
entering and storing responses of said patient to questions contained in said at least one test.

10. The method of claim 9 wherein said step of accessing said computer system by said patient comprises:
generating a passcode that allows access to said computer system;
entering and storing personal information of said patient into said database;
issuing said passcode to said patient.
logging on to said computer system by said patient with said passcode.

11. The method of claim 9 wherein said patient accessing said computer system from a remote location.

12. The method of claim 9 further comprising the step of confirming receipt of said responses of said patient.

13. The method of claim 1 further comprising the step of notifying said professional of availability of said report based on said test score of said patient.

14. The method of claim 1 further comprising the step of billing one of said patient, said professional, and a contracting agency for said at least one psychological assessment test.

15. The method of claim 1 further comprising the step of maintaining billing information to administer purchase orders of said psychological assessment tests from at least one contracting agency.

16. The method of claim 1 further comprising the step of diagnosing said patient by said professional after reviewing said report based on said test score of said patient.

17. A method in a computer system for facilitating the administration of psychological assessments, said method comprising:
entering and storing a plurality of psychological assessment tests in a database;
generating a registration number that allows access to said computer system;
issuing said registration number to a professional;
logging on to said computer system by said professional with said registration number;
generating a passcode that allows access to said computer system;
entering and storing personal information of a patient into said database;
selecting at least one of said plurality of psychological assessment tests for said patient by said professional based upon said personal information of said patient;
determining a method of delivering said at least one of said plurality of psychological assessment tests to said patient;
referring said at least one of said plurality of psychological assessment tests to said patient;
issuing said passcode to said patient;
logging on to said computer system by said patient with said passcode;
entering and storing responses of said patient to questions contained in said at least one psychological assessment test;
scoring test responses submitted by said patient;
generating a report based on a test score of said patient; and
storing said report in said database.

18. A computer readable medium containing instructions for controlling a computer system for facilitating administration of psychological assessments comprising:
referring at least one of a plurality of psychological assessment tests to a patient;
taking said at least one psychological assessment test by said patient;
scoring test responses submitted by said patient; and
generating a report based on a test score of said patient.

19. The computer readable medium of claim 18 further comprising a patient interface accessible by said patient from a location remote from said computer system, said patient interface for facilitating at least one of payment by said patient for said at least one psychological assessment test and taking said at least one psychological assessment test.

20. The computer readable medium of claim 18 further comprising a professional interface accessible by a professional from a location remote from said computer system, said professional interface for facilitating at least one of referring psychological assessment tests to at least one patient, tracking at least one referral, and viewing at least one patient test score.

21. The computer readable medium of claim 18 further comprising an administrator interface accessible by an administrator from a location remote from said computer system, said administrator interface for facilitating at least one of tracking registration of at least one professional as a system users, approving said at least one professional as said system user, maintaining an inventory of said plurality of psychological assessment tests available through said computer system, and maintaining billing information needed to administer purchase orders of a number of said plurality of psychological assessment tests from at least one contracting agency.
